(19) United States
(12) Patent Application Publication
(10) Pub. No.: US 2013/0060938 A1
(43) Pub. Date: Mar. 7, 2013

(54) METHOD AND SYSTEM FOR MONITORING OF ASPECTS FOR USE BY A TRIGGER

(71) Applicant: Research In Motion Limited, Waterloo (CA)

(72) Inventors: Brian McCOLGAN, Toronto (CA); Gaelle MARTIN-COCHER, Toronto (CA)

(73) Assignee: RESEARCH IN MOTION LIMITED, Waterloo (CA)

(21) Appl. No.: 13/668,628

(22) Filed: Nov. 5, 2012

Related U.S. Application Data
(63) Continuation of application No. PCT/CA2011/000527, filed on May 5, 2011.
(60) Provisional application No. 61/331,497, filed on May 5, 2010.

(51) Int. Cl. G06F 15/173

(52) U.S. Cl. 709/224

(57) ABSTRACT

A method and apparatus within a computing execution environment for establishing monitoring of an instance of a context for an observer, including receiving, from a PAL client, a message at the PAL server, the message; requesting establishment of a presence context; resolving an aspect based on the message to establish the presence context, the presence context providing a simplified or abstracted view of presence information on behalf of the PAL client; and placing the presence context into at least one of a monitoring state and a monitoring-capable state if a trigger is associated with the aspect.

### FIELD OF THE DISCLOSURE

The present disclosure relates to aspect triggers, and in particular to monitoring of aspects for use by a trigger.

### BACKGROUND

Applications possess functional utilities that have important characteristics known as context. Context is defined as “the set of information which surrounds, and gives meaning to something else”. Examples of context can be found, for example, in presence applications, location applications, among others. For example, presence information in the form of presence metadata may provide meaning. The meaning is applied to or part of a particular function or a particular feature of a function within an application to establish an appropriate set of processing steps.

A presence service may capture presence information from one or more presence sources. Once this data is collected, a presence service may compose the captured metadata and may distribute a raw presence metadata document to authorized watchers (i.e. logical observers). The OMA-Presence service platform is a demonstrative example of a presence service. The OMA-Presence enabler outlines, in detailed written form, semantics and policy related to the publication and receipt of presence information.

Instead of raw data, presence, location or other generic services may provide aspects to an application based on the raw data, as captured, composed and made available by the presence, location, or other generic information service. The detected change of aspects may result in a trigger being invoked (i.e. fired) which results in a predefined action associated with the trigger. The trigger however needs a mechanism to monitor aspects.

### BRIEF DESCRIPTION OF THE DRAWINGS

The present disclosure will be better understood with reference to drawings in which:

FIG. 1 is a block diagram showing an example generic platform in which a generic context aware mechanism has been added;

FIG. 2 is an example call flow diagram showing call flow for aspects within an OMA/PRS environment;

FIG. 3 is an example call flow diagram showing call flow for aspect triggers;

FIG. 4 is a data flow diagram showing monitoring establishment between a client and a server;

FIG. 5 is a data flow diagram showing monitoring establishment in two stages between a client and a server; and

FIG. 6 shows a state transition diagram for states of a context.

### DETAILED DESCRIPTION

### Terms:

In the present description the following terms are used and defined as follows:
Context That which surrounds, and gives meaning to something else.
Presence Context A contextually aware environment associated with a Presence Aware Service which provides a consolidated view of Presence Information on behalf of a PAL Client.
OMA Open Mobile Alliance
PEEM Policy Evaluation, Enforcement, and Management
Presence Info A basic unit of presence (e.g. activity or mood is presence information).
Presence Service Entity or platform that receives presence information from presence sources.
Presence Source Entity that relates presence info on behalf of 1+ presentities.
Presentity Entity that has presence information related to it.
Watcher Entity that wishes to consume presence information.
PAL Presence Access Layer (a contextually aware layer or mechanism—an x/CAM).
PAL Client A Logical Observer which utilizes a Presence Context (e.g. to request and receive Presence Aspect values from a PAL Server).
PAL Policy A set of guiding principles and rules used as a mechanism to assist a PAL Service in the consolidation of Presence Information on behalf of PAL Clients.
PAL Rule A sequence of logical operations applicable to a Presence Aspect or Presence Trigger.
PAL Server A server that receives and processes PAL request(s) from PAL Clients and returns a corresponding result (e.g. establish and return a Presence Context to a PAL Client).
Presence Aspect A logical abstraction used to consolidate Presence and/or Location Information on behalf of a Logical Observer, based on one or more Presence Information Elements.
Presence Information Dynamic set of information pertaining to a Presentity that may include Presence Information Elements such as the status, reachability, willingness, and capabilities of that Presentity. NOTE: This definition is compatible with the 3GPP/3GPP2 definitions, as well as the IETF definition, though the latter is quite generic.
Presence Information Elements A basic unit of Presence Information.
Presence Trigger A mechanism used to detect changes affecting a Presence Aspect and as a result, execute a predefined action.
Presentity A logical entity that has Presence Information associated with it. This Presence Information may be composed from a multitude of Presence Sources. A Presentity is most commonly a reference for a person, although it may represent a role such as “help desk” or a resource such as “conference room #27”. The Presentity is identified by a SIP URI, and may additionally be identified by a tel URI or a pres URI.
PS Presence Server
Context Aware Layer A Layer that may be an access, application abstraction or proxy layer. This layer may make use of aspects. This layer may be deployed over a network and may be adapted to handle requests from a plurality of clients of various types. This layer may include context aware mechanisms such as, for example an x/CAM, which is a non-specific (generic) context aware mechanism, or specific mechanisms such as presence (p/CAM) and location (L/CAM).
LS Location Server
Monitoring A characteristic or property of a context. A context (at an aggregate level) is considered to be ‘monitoring’ when the context itself is ‘monitoring capable’ and at least one Aspect request (for one or more Presentities) by the PAL Client applies for a duration over a corresponding Trigger. Monitoring may also apply to individual Aspects (e.g. monitoring=true for Aspect ‘available’).
Monitoring Capable A context which consists of at least one Aspect with a corresponding Trigger.
PI Push Initiator—a term utilized by OMA Push to describe an entity that initiates push-able content (e.g. a PAL Server).
SIP Session Initiation Protocol
URI Uniform Resource Identifier
XML eXtensible Markup Language

### Description:

The present disclosure provides a method performed by a presence access layer (PAL) server, comprising receiving, from a PAL client (410, 510), a message (430, 530) at the PAL server (420, 520), the message (430, 530); requesting establishment of a presence context (440, 540); resolving an aspect based on the message (430, 530) to establish the presence context (440, 540), the presence context (440, 540) providing a simplified or abstracted view of presence information on behalf of the PAL client (410, 510); and placing the presence context into at least one of a monitoring state (640) and a monitoring-capable state (630) if a trigger is associated with the aspect.

The present disclosure further provides a processor configured to execute a PAL server for performing the method of receiving, from a PAL client (410, 510), a message (430, 530) at the PAL server (420, 520), the message (430, 530); requesting establishment of a presence context (440, 540); resolving an aspect based on the message (430, 530) to establish the presence context (440, 540), the presence context (440, 540) providing a simplified or abstracted view of presence information on behalf of the PAL client (410, 510); and placing the presence context into at least one of a monitoring state (640) and a monitoring-capable state (630) if a trigger is associated with the aspect.

The present disclosure still further provides a computer-readable medium storing instructions thereon which, when executed, cause a computing device to perform the method of receiving, from a PAL client (410, 510), a message (430, 530) at the PAL server (420, 520), the message (430, 530); requesting establishment of a presence context (440, 540); resolving an aspect based on the message (430, 530) to establish the presence context (440, 540), the presence context (440, 540) providing a simplified or abstracted view of presence information on behalf of the PAL client (410, 510); and placing the presence context into at least one of a monitoring state (640) and a monitoring-capable state (630) if a trigger is associated with the aspect.

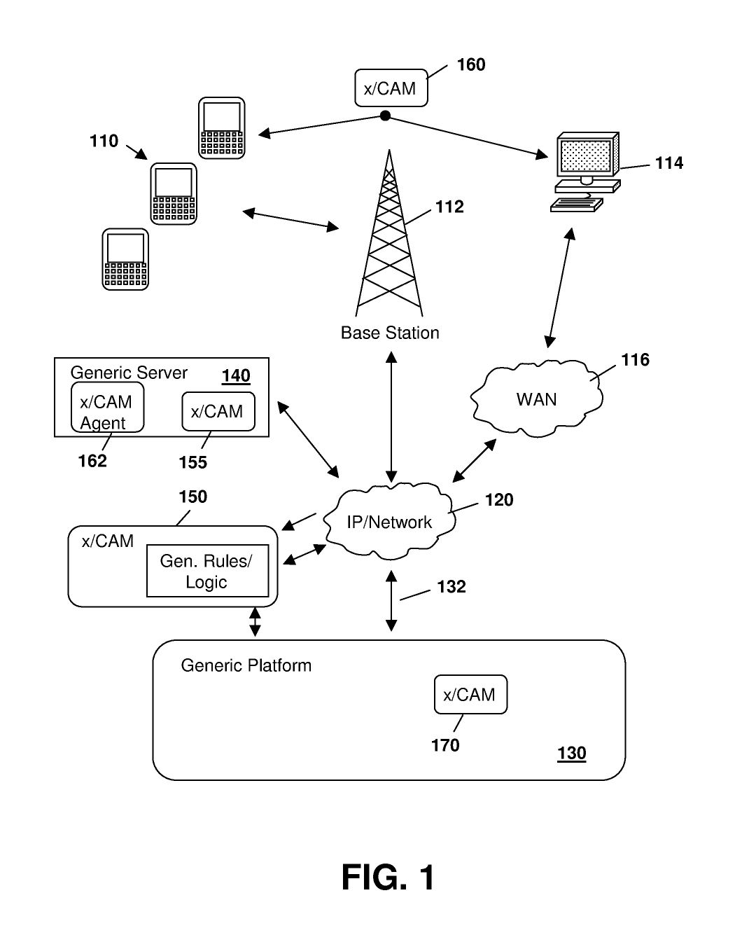

Reference is now made to the drawings. FIG. 1 illustrates a block diagram of an example presence platform being employed in the context of a generic system. The generic system may be any location, presence or other type of system and can include as an example a push to talk over cellular (PoC) system, a location system, an instant messaging (IM) system, among others. Specifically, in FIG. 1, user devices 110 communicate over a wireless communication (e.g., cellular) system with a base station 112, which then communicates with an Internet Protocol network 120 or other network as known to those skilled in the art. As will be appreciated, base station 112 could be a base station for any known wireless communication (e.g., cellular, PCS, iDEN, etc.) service. Further, devices 110 could communicate with a network 120 throughout other means such as a short range wireless communication like Bluetooth™ or near field communications, over WiFi, WiMAX or WLAN, through a wired connection such as through a USB or Serial port or through a computer modem. Indeed, other means of connecting to network 120 would be known to those skilled in the art.

In the system of FIG. 1, a desktop 114 (e.g., a computing device that is similar or different than user devices 110) communicates with one or more of the user devices 110 through a wide area network 116 and an Internet Protocol network 120.

A generic platform 130 receives requests and sends out information flow from network 120 to user devices 110 or desktop 114. As will be appreciated, generic platform 130 may be a presence platform or location platform in some embodiments. Generic platform 130 is configured to store raw data regarding states of clients and to update client records when new state data is received. Generic platform 130 is further adapted to provide information to a watcher. Such information may, in some embodiments, be presence information if generic platform 130 is a presence platform, or may be location information if generic platform 130 is a location platform. Thus information flows both to and from generic platform 130.

A generic server 140 exists within the system of FIG. 1 and in one embodiment could publish state information on behalf of a presentity or a watcher. For example, generic server 140 may be a push talk over cellular (PoC) server. As will be appreciated by those skilled in the art with reference to FIG. 1, the consumption and interpretation of information metadata to achieve functions or features within the context of an application relating to a subject of interest may be performed by the application. An application in this case could be the PoC server, a PoC client or an IM client, among others.

User devices 110, desktop 114 and generic server 140 could act as both watchers and information (eg. presence, location) sources in the example of FIG. 1.

In the present disclosure, examples provided may include presence. This is for illustrative purposes and is not limiting. Specifically, generic information or location information would also apply in the embodiments of the present disclosure.

For example, a “watcher” is interested in whether a target (“presentity”) can be reached for an instant messaging chat. A presence service may provide raw metadata regarding the status of the presentity. However, as will be appreciated by those skilled in the art, the consumption and interpretation of presence metadata by a watcher (particularly on a resource constrained mobile wireless device) to achieve functions or features within the context of an application that is presence aware increases the complexity of both implementing, deploying and running a client application. Undesirably, this complexity has the net effect of increasing the associated memory footprint as well as the overall processing, power consumption and network bandwidth usage for the application. In addition, a presence related application is directly coupled to the presence metadata elements and further becomes susceptible to changes or additions to the underlying metadata or with changes to presence platform semantics or policy. For example, a bug fix or a change in the Open Mobile Alliance (OMA) standards could lead a client application to be updated or changed in order to correctly interpret metadata in the future. Also, presence semantics could be added or changed with respect to metadata.

The use of raw information has the net effect of frequent changes to the application deployed within a user's execution environment in order to properly maintain an appropriate watcher, view, or both, of a given presentity. Further, the contextual interpretation of presence information may be embedded within each client based on the particular presence application. In a further embodiment, context is established based on the service or application a user is requesting and optionally who the requester is and further optionally who the target is. The presence aware application (typically hosted in the network) may determine or have an impact on the baseline ‘presence’ context used. Each client application can receive a different or the same set of presence metadata and in situations where multiple applications share the same raw presence metadata, the fact that the contextual interpretation is individually tied to each of them increases the possibility that two different client applications will arrive at differing conclusions about a specific presence aspect. Thus, two services such as Google™ IM and MSN™ IM service utilizing presence information from the same source (i.e. the same presence platform for an identical presentity, who has exposed presence information for a general IM presence aware service or class of service) could cause inconsistent results. The differing implementations of ‘reachability’ for each of those client applications could derive or calculate differing results, based on identical underlying presence information. The differing results may not provide the desired outcome and may lead to interoperability issues, particularly between client applications that are relied on to share or treat specific presence aspects in an orthogonal and consistent manner.

Abstracting raw presence information into a dedicated context aware layer or mechanism which supports “presence aspects” based on contextual rules and policies allows for the possibility of applications to work collaboratively to achieve derived functionality and to carry out intelligent workflows as a result of a compound context presence. For example, a project manager wishes to host a project status meeting. The project manager establishes a meeting invitation (e.g., from an enterprise email/calendaring application) on her desktop execution environment to meeting participants. A presence-context platform working on behalf of the mail/calendaring application may be able to support the following types of functions as a result of the user initiating the invite:
Determine an appropriate time based on participant availability;
Based on contextual policy, book an appropriate meeting room for the meeting;
Determine based on participant location (and enterprise policy) whether a conference bridge must be booked (and reflect this to appropriate individuals in the meeting request);
Based on hints or policy given by the meeting moderator through the application, invite relevant participants who fulfill a given criteria (e.g. a member of the marketing team, a member of the development team, a member of the quality assurance (QA) team, an individual with a specific skill or knowledge, etc.).

Further, various application servers can integrate the presence context aware mechanism (P/CAM) to gain efficiency by reducing the number of communication and processing steps. For example, a mobile advertisement server could integrate with a P/CAM to simplify and streamline its presence aspects to focus on core functionality such as the delivery of contextually relevant mobile advertisements. This would have the net effect of a presence aware mobile ad service which imposes no additional computational burdens on behalf of wireless mobile ad clients.

A context can be established where a mechanism is connected with a server platform to support a given application. Context awareness resides in whole or in part within the network and provides a composite view of presence/location or other related aspects to an application or multiple applications (e.g., a collection of applications related to a single service) on behalf of various entities such as a given presentity and/or watcher in the presence case. For each case, this is achieved by associating rules, triggers, and policies against presence related aspects such as availability, contactability, reachability, state, among others, into a context aware layer. Rules or triggers may be extended or overridden to provide additional or application specific behavior to different classes of applications or enablers.

Context awareness may be replicated to a presence or location context aware mechanism connected with a presence or location service platform to provide a client application or a service with location related aspects. A location context aware mechanism (L/CAM) makes use of location information provided by a location enabler, location information stored in a presence service or other location information store. For example, the location could be derived using GPS, base station, or extended cell tower information.

Location specific rules and policies are associated against location related aspects such as within a geographical area, who is close by, am I there yet, among others, into a location context aware layer. As with a P/CAM, rules or triggers may be extended or overridden to provide additional/application specific behavior to different classes of applications or service enablers.

Similarly, a “generic” context aware layer (context aware mechanism) could contain a combination of a P/CAM, L/CAM and specific application context aware mechanism. An example could be a mobile advertising platform where presence, location and campaign related information are used in combination to target advertisements of interest towards a user. Other generic platforms could include a network address book service, a network community service, among others.

As will be appreciated by those skilled in the art, a context aware mechanism is applicable to both a wired and wireless execution environment and computing domain. This approach has several benefits including a dramatic reduction in the complexity of an associated application running within a user's execution environment. A contextually aware platform located on the network, or split across a network or one or more devices, or split across the network and one or more devices, permits a given client application or enabler to focus on its core competency such as chat within an IM client, visualizing a person's location in a location client, among others. Functionality is achieved by establishing a context (e.g., Presence Context) which injects (e.g., at execution time) the applicable policies and invokes specific rules, triggers, or both, relevant to the context of the service, client application or the enabler to provide utility on behalf of the user.

In a further embodiment, a context aware platform or context aware layer includes both an x/CAM server and an x/CAM client or agent that work in concert. Further, in some embodiments of the x/CAM, the same distributed or non-distributed aspects as the P/CAM and L/CAM mentioned above are possible. For instance, the context aware layer may exist only server side in some embodiments. The context aware layer client or agent is embedded within an execution environment. The interface to a context aware platform may be web-centric. Examples include extensible markup language (XML) web services such as simple object access protocol (SOAP), representational state transfer (REST) or XML over hypertext transfer protocol (HTTP). The above supports a context aware layer deployment scenario whereby an application or enabler could directly interact or manipulate the context aware mechanism to more closely model the appropriate behavior. For example, a mobile advertising server co-located with a P/CAM agent could be used to override presence policies to better align presence with the underlying functionality of the platform. For example, a mobile advertising server can integrate or make use of an x/CAM ‘layer’. Such x/CAM could be a superset of a P/CAM, L/CAM and specific advertisement /CAM.

Referring again to FIG. 1, a generic context aware mechanism server 150 provides the context aware layer and communicates with network 120 and resolves applicable context from policies, rules, aspects and triggers received over network 120. The sources of this information could be clients (110, 114) but could also be other enablers, such as the resolution of policies based on a ‘policy evaluation request’ made by x/CAM 150 to a PEEM or policy evaluation functional entity (not shown) The generic context aware mechanism server 150 further publishes and receives “aspects” through network 120.

The context aware mechanism server 150 further communicates with generic platform 130 to provide and receive presence information flow.

Link 132 remains despite the communication link between presence platform 130 and x/CAM server 150 in order to allow clients who want to communicate directly with the generic platform 130, the ability to do so or to provide for communications with the platform 130 for new information or advanced information that the x/CAM server 150 may not yet be aware of.

Based on the above, x/CAM server 150 resolves applicable context utilizing characteristics such as an application or service identifier received from device 110 or desktop 114 or generic server 140, and resolving parameters such as policies, rules, aspects and triggers.

In other embodiments, various aspects or functionality of the x/CAM can be distributed throughout the network and in some instances the entire x/CAM can be placed onto other devices or clients within the network.

Specifically, some or all of the functionality of x/CAM server 150 may optionally be distributed in order to allow the full functionality of the x/CAM, or part of it, to be performed on the device 110, desktop 114 or generic server 140, for example. This is illustrated by x/CAM agent 160 on user devices 110 or desktop 114 and x/CAM agent 162 on generic server 140. In the latter case, the context aware layer comprises both x/CAM server 150 and x/CAM agent 160, 162 or both.

x/CAM agent 160 or 162 could contain rules, policies, or both, that are predefined. Further, the x/CAM agent 160 or 162 can be used to manipulate information or interoperate with metadata or clients on the host execution environment in some embodiments.

In some embodiments the entire x/CAM can be located on a client or other server.

Further, in one embodiment, x/CAM server (context aware layer) 155 may be embedded within the generic server 140. In other embodiments, x/CAM server 170 may be embedded in generic platform 130. The various x/CAM servers 150, 170, 155, 160 thus do not all need to be present, and illustrating all of them in FIG. 1 is merely meant to show the various locations possible for such x/CAM server.

Referring to FIG. 1, context awareness reduces network latency by reducing the amount of data (size and volume) transmitted between a user's execution environment and a presence, location or generic information platform. Case studies focusing on presence have shown that in some cases, a fourfold improvement or more may be achieved through a context aware layer compared with OMA PRS. This is helpful in a wireless domain where CPU usage, battery consumption and network bandwidth are precious resources. Further, given a context abstracts the specific details of a presence platform, a client application or enabler is less brittle and significantly more resistant to underlying changes in the model or semantics of the presence/location/generic platform. Context also provides an application or service with implied filtering (further reducing what needs to be considered by wireless devices). That is a context contains relevant rules, policies, aspects, and triggers to support an associated service.

The above may be implemented utilizing policies and rules/aspects/triggers. A process relating to this mechanism is provided below.

In accordance with one embodiment, a context or mechanism, whether it is presence, location or generic, may include one or more of policies, aspects, rules and triggers. Each is described in detail below.

### Policy:

Policy is associated with a particular presence context at an appropriate point in the application life cycle, to specify the behavior or treatment of presence, location or generic related aspects. Policies augment rules/logic flows in terms of how they operate, to provide a more accurate and meaningful computation of aspects on behalf of a client application or enabler. As will be appreciated, a policy can apply to a class of applications, an individual application or even to a user and can be provisioned with settings on how aspects are computed.

Policy may be expressed using the Open Mobile Alliance's (OMA) policy evaluation, enforcement and management (PEEM)/policy expression language (PEL). PEL defines a generic and extensible grammar in which policies may be expressed using a rule set language. PEL is based on Internet Engineering Task Force (IETF) request for comments (rfc) 4745. Conditions and/or actions (as specified in rfc 4745) may be enhanced within the scope of PEEM, through the OMA XDM (XML Document Management) common policy extensions, as detailed in OMA-SUP-XSD_XSD_xdm_extensions-V1_{—}0.

PEEM is a continuing standards effort by the OMA to define common functions for its enablers.

As an example, the following table describes relevant presence policies for use by a presence context in the computation of presence aspects. These policies have applicability to the OMA presence platform. However, given policies may be added or removed from the given context and the concept is applicable to a multiplicity of presence platforms. In the table below, the default value, if applicable, is shown in italics.

TABLE 1
Presence Policies

| Policy | Description | Values |
|---|---|---|
| opt-in-source | Indicate which pres. element is | willing \| |
| | an indicator of service opt-in. | ignore |
| | Default value indicates opt-in not | |
| | relevant for the given comm. | |
| | service. | |
| applicable-network- | Indicate the applicable network | IMS, SIP, <token>, . . . |
| type | type(s) for the given comm. | |
| | service. | |
| threshold-value- | Establish an equality comparison | <label> <qn-elem> <value> |
| equals | operation threshold named label, | |
| | with qn-elem, and value. A | |
| | boolean value of ‘true’ or ‘1’ or | |
| | ‘yes’ would apply if the policy | |
| | was applied to the xml-ns and | |
| | the resulting target matched | |
| | value. | |
| threshold-value-less- | Identical to equality, with the | <label> <qn-elem> <value> |
| than | exception that the comparison | |
| | operator is less than (<). | |
| threshold-value- | Identical to equality, with the | <label> <qn-elem> <value> |
| greater-than | exception that the comparison | |
| | operator is greater than (>). | |
| unavailable-activies- | Indicate the subset of activities | busy, holiday, meal, in-transit, |
| set | from the watcher perspective that | permanent-absence, sleeping, |
| | would render a contact | unknown, worship |
| | unavailable. This set may be | |
| | defined as empty which is an | |
| | indication that activities has no | |
| | bearing on availability. | |
| undef-servcaps-sub- | Indicate how to interpret the | unknown \| unsupported |
| elements | absence or omission of specific | |
| | <servcaps> sub-elements in | |
| | presence metadata. | |
| undef-barring-state | Indicate how to interpret the | ignore \| active \| terminated |
| | absence or omission of <barring- | |
| | state> sub-elements in presence | |
| | metadata. | |
| undef-registration- | Indicate how to interpret the | ignore \| active \| terminated |
| state | absence or omission of | |
| | <registration-state> sub-element | |
| | in presence metadata. | |
| undef-willingness | Indicate how to interpret the | (open,indefinite) \| (closed,indefinite) |
| | absence or omission of | \| (open,time-ofs-value) \| (closed,time- |
| | <willingness> for the given | ofs-value) |
| | comm. service. | |

Table 1 above defines various policies and values for the policies. As indicated in the table, various policies exist and the description of the policy and the values are provided.

As an example, in the first row of the table, a first policy is “opt-in-source”. The policy is used to indicate which presence element is an indicator of service opt-in. The default value indicates that opt-in is not relevant for the given communication service.

The values that are possible for the opt-in-source policy are willing, or ignore. As will be appreciated, these could be selected by various entities such as the service provider, among others. The entity choosing the policy can choose which values to utilize. Thus, for example, the service provider could choose to ignore opt-in source for the first policy.

Table 1 above is merely meant as an example and other policies are possible based on the needs of a system or user.

### Aspects:

Aspects are application level abstractions relevant to a source. For example, presence aspects are application level abstractions relevant to presence. Presence aspects can be considered the conceptual interface of a presence context to a P/CAM client application or enabler. Table 2 below outlines a base set of applicable presence aspects that may be incorporated for use by a presence context aware mechanism and exposed to client applications. For each presence aspect, a description is provided, along with the associations the aspect relates to in terms of the standard presence data model outlined in IETF rfc 4479.

In particular, to specify and apply contextually relevant behavior across a disparate set of interworking components and user devices, a general mechanism is possible for the encapsulation of aspects related to a presence platform. That is, an aspect captures a first-order abstraction related to a given application or enabler. Aspects relating to a presence platform would describe or relate to underlying indications of presence. Aspects may be expanded to encapsulate other indications as well. For example, location may be incorporated (or inferred) to derive or compute an associated aspect within a presence platform. This is illustrated in Table 2 below with regard to the who-is-nearby aspect.

The present disclosure provides a mechanism for an arbitrary number of aspects for the presence platform. These may include common aspects which apply over a variety of different applications and/or contexts, such as availability and reachability. They may also include application specific aspects such as mobile-ad-campaign-eligible-participant. A mechanism within the presence platform or management interface exists to associate an appropriate set of aspects with a given service. Associations of aspects are contextual in nature and may apply at different levels. For example, a given aspect may apply to a service enabler such as all OMA push-to-talk over cellular (i.e. PoC) compliant service.

An aspect may also be applicable at a user or group level.

For each aspect, an associated set of rules or logic may be defined which outline the steps or processing performed to achieve the given aspect. The logic also identifies the raw presence/data indicators/elements from the information source(s) relevant to the calculation of the associated aspect. A given aspect may combine two or more predefined rules together as part of its logic processing. Further, underlying logic may be reused as a library or routines in support of aspects within a presence platform. This library may include aspects as other high-level modules or components which may be incorporated. This allows multiple client application types to utilize a context aware layer.

In one embodiment presence aspects are extensible. For example, if a given service or enabler wants specific functionality, the presence platform could support the extension or re-definition in one or more aspects.

As will be appreciated by those skilled in the art, Table 2 may be modified or extended to support other presence platforms or application/enabler criteria. The particular presence aspects shown in Table 2 are demonstrative of an OMA presence platform.

TABLE 2
Presence Aspects

| Presence | | | | Common |
|---|---|---|---|---|
| Aspect | Description | Associations | Visibility | visibility |
| opt-in | Presentity is willing to | Person −> | OTA, | Server |
| | participate in a | service. | Server | |
| | session for a given | | | |
| | service or application. | | | |
| Available | Presentity is available | Person −> | OTA, | Server |
| | to communicate using | service. | Server | |
| | a given service or | | | |
| | application. | | | |
| contact-means | Presentities most | Person(addr) −> | OTA, | Server |
| | applicable method of | service. | server | |
| | contact for a given | | | |
| | service or application. | | | |
| contactable | Presentity is willing, | Person(addr) −> | OTA, | Server |
| | available, and has a | service. | server | |
| | currently valid contact | | | |
| | means for a given | | | |
| | service or application. | | | |
| reachable | Presentity is | Person −> service −> | OTA, | OTA |
| | contactable for a | device | server | |
| | given Service or | | | |
| | application. | | | |
| | NOTE: A positive | | | |
| | indication for | | | |
| | reachable indicates | | | |
| | that a presentity is | | | |
| | willing, available, | | | |
| | contactable, and their | | | |
| | device is in-coverage | | | |
| | to establish | | | |
| | communication over | | | |
| | the defined service. | | | |
| where-are-you | Presentities current | Person, | OTA, | OTA |
| | location. | Person −> service −> | server | |
| | | device | | |
| personal-avatar | Presentities current | Person | OTA, | OTA |
| | personal iconic | | server | |
| | representation. | | | |
| service-avatar | Presentities current | Person −> service | OTA, | OTA |
| | iconic representation | | server | |
| | for a given service or | | | |
| | application. | | | |
| personal-interests | Presentities current | Person(extended- | OTA, | Server |
| | interests or hobbies. | info) | server | |
| who-is- | Watchers that | Winfo | OTA, | Server |
| subscribing-to-me | currently have | | server | |
| | ‘pending’ | | | |
| | subscriptions for a | | | |
| | given presentity. | | | |
| who-is-nearby | A list of zero or more | Person −> service | OTA, | Either |
| | presentities that are | | server | |
| | within close proximity | | | |
| | and meet an optional | | | |
| | set of criteria (e.g. | | | |
| | interested in football). | | | |
| who-is-blocked | Watchers who have | Winfo, common- | OTA, | Server |
| | had subscriptions | policy | server | |
| | terminated or have | | | |
| | been blocked for a | | | |
| | given presentity | | | |
| eligible-session- | Whether a presentity | Person −> service −> | OTA, | Server |
| participant | is reachable and | device, | Server | |
| | meets an optional set | Shared | | |
| | of criteria in order to | UserProfile, | | |
| | participate in a | Other XDMS | | |
| | session of the | meta-data | | |
| | associated service. | | | |
| Session- | An indicator of | Person −> service | OTA, | OTA |
| answermode | whether a presentity | | Server | |
| | will accept an | | | |
| | incoming session for | | | |
| | a given service in | | | |
| | automatic (no | | | |
| | intervention) or | | | |
| | manual (user must | | | |
| | accept/reject) mode. | | | |
| what-are-you- | Presentities current | Person. | OTA, | Server |
| doing | activity. | | Server | |
| active-barring | An indicator of | Person −> | OTA, | Server |
| | whether a Presentity | service. | Server | |
| | is actively barred or | | | |
| | not for the given | | | |
| | comm. service. | | | |
| active- | An indicator of | Person −> | OTA, | Server |
| registration | whether a | service. | Server | |
| | presentity is | | | |
| | actively registered | | | |
| | for the given | | | |
| | comm.. service. | | | |
| how-are-you | Presentities current | Person. | OTA, | OTA |
| | mood. | | Server | |
| time-zone | Presentities current | Person. | OTA, | OTA |
| | timezone. | | Server | |
| network- | Presentities current | Person −> service −> | OTA, | OTA |
| availability | network availability | device | Server | |
| | for an associated | | | |
| | comm. device. | | | |
| preferred- | Presentities relative | Person −> service | OTA, | Server |
| service | service preference. | | Server | |
| involved- | Whether a presentity | Person −> service | OTA, | Server |
| session | is currently involved | | Server | |
| | in a session of the | | | |
| | associated service. | | | |
| session-count | Total number of | Person | OTA, | OTA |
| | communication | | Server | |
| | sessions presentity is | | | |
| | involved in. | | | |
| device- | The current | Device | OTA, | OTA |
| orientation | orientation of the | | Server | |
| | device | | | |
| device- | The current | Device | OTA, | OTA |
| capabilities | capabilities of the | | Server | |
| | device | | | |

Table 2 defines various presence/application/service aspects applicable to a presence platform. For each aspect there is a short description along with the association or applicability of the aspect to the standard presence data model. In addition, the visibility is declared. Visibility describes the applicable point at which the associate aspect is referred to. Common visibility defines or declares the most common or relevant point at which the associated aspect is likely to be referred. Choices for visibility include over the air (OTA) versus server. As would be appreciated, “server” would exist on the network side in an application server.

For example, in the first row of Table 2 above, the opt-in aspect is defined which indicates that the presentity is willing to participate in a given session for a given service or application. As indicated in Table 2, the person is associated with the service.

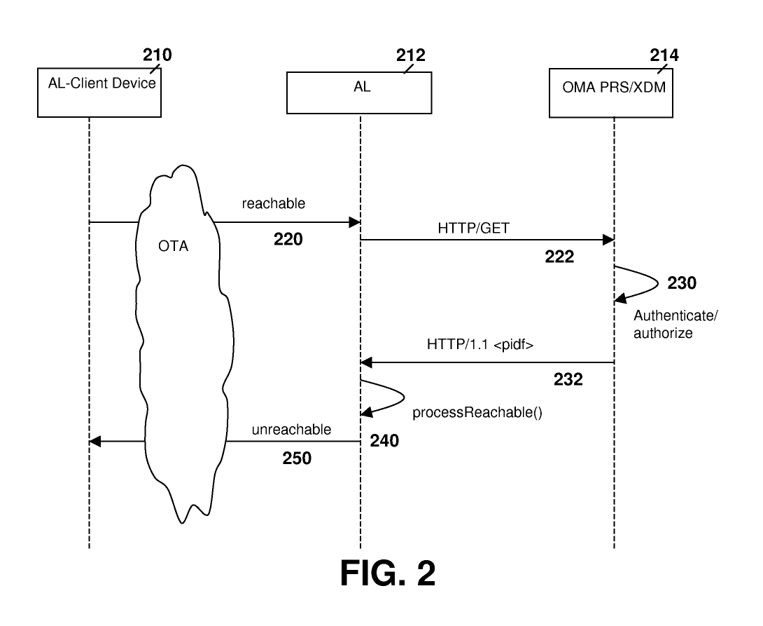

For an OMA presence realization, an example presence platform call flow may look like that shown in FIG. 2. Those skilled in the art will appreciate that FIG. 2 shows that the context aware layer may be configured between a client device and the OMA presence/XDM layer. In one embodiment, the access layer (AL) can be an application layer or proxy. Such a context aware layer could be a separate layer or an internal layer of the application (for example a mobile advertising application with a split or integrated context aware layer).

As shown in FIG. 2, the aspect “reachable” may include further processing which incorporates rules and possibly the use of other aspects in the computation. As previously noted, these aspects may exist within a standard library of aspects for reuse within higher level applications or service aspects.

Reference is now made to FIG. 2. FIG. 2 shows a client device 210 which communicates with an access layer (AL) 212 (e.g., a context aware layer (CAL)), which in turn communicates with a presence service (e.g. OMA PRS), a network database or document storage (e.g. an XDMS), or both, shown as OMA PRS/XDM 214.

Client Device 210 establishes a context for a relevant application or service, via AL 212 (not shown). Subsequently, client device 210 sends a query concerning the presence aspect “reachable”, shown as communication 220. In turn, access layer (AL) 212 sends an HTTP/GET request 222 to OMA PRS/XDM 214. Alternatively AL 212 may issue a SIP:SUBSCRIBE request 222 to OMA PRS/XDM 214. Either of these requests provide the AL 212 with ‘raw’ information (in subsequent response 232) to consolidate and evaluate the ‘reachable’ aspect indicator on behalf of client device 210.

OMA PRS/XDM 214 authenticates as shown by 230 and returns a response (i.e. to the HTTP/GET request) in the form of an HTTP/1.1 <pidf> 232. Alternatively, OMA PRS/XDM 214 may issue one or more SIP:NOTIFY requests 232 to AL 212 corresponding to the SIP:SUBSCRIBE issued by AL 212.

AL 212 then checks whether the presentity (i.e. the observable) is reachable, through rules associated with the context, as shown by arrow 240. The processing within the AL 212 for the aspect “reachable” invokes other rules for other, possibly dependant aspects, such as “contactable”, “contact-means”, “available” and “opt-in or willing”.

The arrow shown by 240 determines that the presentity (in this example) is unreachable and returns this in message 250.

As shown in FIG. 2 reachable request 220 and unreachable response 250 travel over the air. However, this is meant only as an example and other communications techniques would be applicable in different embodiments.

### Rules/Triggers:

A third branch of the context awareness mechanism solution consists of rules, triggers, or both. The example below uses presence as an example.

Rules reside within a presence context and establish a sequence of steps or logic flows for computing presence aspects based on the metadata provided by the underlying presence platform. Rules are conceptually similar to database stored procedures or user-defined functions (UDFs). Base or default presence rules may be changed or supplemented by an application client or an individual user. For example, the injection by a client of dynamic rules may override or extend base rule behavior. In addition, rules incorporate policies associated with the presence context by the application or the enabler to augment or provide hints surrounding the interpretation of metadata. This permits an application or service to directly affect the outcome of one or more presence aspects.

Table 3 below shows a set of rules relating to computation of presence related aspects with pseudo-logic specific to the OMA presence platform. It should be noted that this is only a subset of the rules/logic that may be exposed by a presence context. It is possible to change the composition or granularity of rules by the presence context. In addition, it is possible for a presentity or watcher to continue to fetch or be notified of raw presence information by the underlying presence platform in order to reach specific conclusions if context is not applicable. This could occur in specific situations.

As used in Table 3 below, ‘def’ indicates “defined” and means that the entity exists and is established with reasonable values, whereas ‘undef’ means “undefined”—the complement of ‘def’. Under thus has values such as nil, null, or invalid.

‘Valid’ in Table 3 below means the associated entity still contains timely or meaningful data.

TABLE 3
Rules

| Rule | Description | Pseudo-logic | |
|---|---|---|---|
| findServicePresInfo | Return most applicable pres. | ▪ | For each <tuple> ‘t’ in list with |
| | information element ‘svc’ for the given | | t.service-id == service-id |

| | | |
|---|---|---|
| service or application within | ∘ | Items.add(‘t’) |

| | | |
|---|---|---|
| service ‘list’. | ▪ | If Items.size == 1 |

| | | |
|---|---|---|
| NOTE: pseudo-logic method | ∘ | Res=Items[0] |

| | | |
|---|---|---|
| ‘resolveService( )’ implements | ▪ | Else |

| | | |
|---|---|---|
| semantics outlined in OMA-TS-Pres | ∘ | Res=resolveService(Items |

| | |
|---|---|
| V2_0 Section (5.2.3). | ) |

| | | | |
|---|---|---|---|
| | | ▪ | Return Res |
| hasOptedInForService | Makes use of opt-in-source policy to | ▪ | Switch (opt-in-source policy) |
| | establish a user ‘p’ willingness to | ▪ | Case willing: |

| communicate given a service or | ∘ | Uwp=undef-willingness |
|---|---|---|
| application ‘svc’. | | policy |
| Willingness is an | ∘ | If svc.willingness undef |

| | | |
|---|---|---|
| ordered pair (open\|closed, | ▪ | Return Uwp |

| | | |
|---|---|---|
| indefinite\|time-ofs-value). | ∘ | Else |

| | | |
|---|---|---|
| NOTE: pseudo-logic method | ▪ | Return |

| | |
|---|---|
| implements semantics outlined | svc.willingness |

| | | |
|---|---|---|
| in OMA-TS-Pres V2_0 Section | ▪ | Case session-participation: |

| | | |
|---|---|---|
| (10.4.1). | ∘ | Return |

Willingness(svc.session-
participation, indefinite)

| | |
|---|---|
| ▪ | Default: // ignore |

| | |
|---|---|
| ∘ | Return Willingness(open, |

indefinite)

| | | | |
|---|---|---|---|
| isAvailable | Return boolean value indicating | ▪ | Urs=undef-registration-state |
| | whether a presentity ‘p’ is | | policy |
| | available to communicate for a | ▪ | Ubs=undef-barring-state policy |
| | given Service or applicaiton ‘svc’. | ▪ | Uas=unavailable-activities-set |
| | NOTE: pseudo-logic method | | policy |
| | implements semantics outlined | ▪ | If (p.activities valid and |
| | in OMA-TS-Pres V2_0 Section | | <activities> non-empty-set) |

| | | |
|---|---|---|
| (10.4.3). The logic in this method also | ∘ | For each <activities> ‘a’ in |

| | |
|---|---|
| factors in activity (if directed to by | p: |

| | | |
|---|---|---|
| policy) into availability | ▪ | If (‘a’ match 1+ |

| | |
|---|---|
| calculation. | element in Uas) |

| | |
|---|---|
| ▪ | Return False |

| | |
|---|---|
| ▪ | If (svc.reg-state undef) |

| | |
|---|---|
| ∘ | If (Urs == ‘ignore’) |

| | |
|---|---|
| ▪ | Reg-state=active |

| | |
|---|---|
| ∘ | Else |

| | |
|---|---|
| ▪ | Reg-state=Urs |

| | |
|---|---|
| ▪ | Else |

| | |
|---|---|
| ∘ | Reg-state=svc.reg-state |

| | |
|---|---|
| ▪ | If (svc.bar-state undef) |

| | |
|---|---|
| ∘ | If (Ubs == ‘ignore’) |

| | |
|---|---|
| ▪ | Bar-state=active |

| | |
|---|---|
| ∘ | Else |

| | |
|---|---|
| ▪ | Bar-state=Ubs |

| | |
|---|---|
| ▪ | Else |

| | |
|---|---|
| ∘ | Bar-state=svc.bar-state |

| | |
|---|---|
| ▪ | If (Reg-State == ‘active’ AND Bar- |
| | state == ‘active’ AND |
| | svc.status.basic == ‘open’) |

| | |
|---|---|
| ∘ | Return true |

| | | | |
|---|---|---|---|
| | | ▪ | Return false |
| establishContactMeans | Return applicable contact ‘c’ for a | ▪ | Return svc.contact |
| | given a service or application service | | |
| | ‘svc’. | | |
| | NOTE: pseudo-logic follows rfc | | |
| | 3863. | | |
| isContactable | Return a valid ContactMeans | ▪ | W = |
| | consisting of the tuple | | hasOptedInForService(p,svc) |
| | (contact, Idev, validity) if a presentity ‘p’ | ▪ | If (W valid AND |
| | is contactable for a given service or | | isAvailable(p,svc)) |

| applicaiton‘svc’. | ∘ | C = |
|---|---|---|
| NOTE: pseudo-logic method | | establishContactMeans(s |
| implements semantics outlined | | vc) |
| in OMA-TS-Pres V2_0 Section | ∘ | If (C def AND svc.deviceID |

| | |
|---|---|
| (10.4). | def) |

| | |
|---|---|
| ▪ | Cm=ContactMeans |

(

Contact, svc.deviceID(s),

w.validity)

| | |
|---|---|
| ▪ | Return Cm |

| | | | |
|---|---|---|---|
| isReachable | Return boolean value indicating | ▪ | Ant=applicable-network-type |
| | whether an applicable device | | policy |
| | ‘dev’ may be reached over the | ▪ | If (cm valid) |

| | | |
|---|---|---|
| network type given a | ∘ | For each ‘d−>deviceID’ in |

| | |
|---|---|
| contactable contact-means. | Idev: |

| ▪ | Find ‘dev’ in |
|---|---|
| | <device> elements |
| | where dev.deviceID |
| | == ‘d−>deviceID’ |
| ▪ | If match |

| ▪ | For each |
|---|---|
| | <network> |
| | ‘n’ in ‘dev’: |
| ▪ | If (‘n’.id |
| | match 1+ |
| | element in |
| | Ant and ‘n’ |
| | available) |
| ▪ | Return true |

| | |
|---|---|
| ▪ | Return false |

Table 3 above describes a number of rules. The first rule defined is ‘findServicePresInfo’ which returns the most applicable presence information element for the given service or application within a service list. As indicated in the pseudo logic, for each tuple t in the list, a check is made to see whether the service-id of ‘t’ matches the desired service-id, and if so the tuple t is added to a list. Thereafter, once the compilation is finished, if the item size is 1 then that item is returned. Otherwise the function ‘resolveService’ is invoked. As will be appreciated by those skilled in the art, the ‘resolveService’ function is an OMA specific function that finds the most relevant service.

Similar rules are defined with regard to the remainder to the Table 3, in which various pseudo logics are utilized to define what will be returned when a rule is implemented.

The other portion of the rules/triggers branch is triggers. Triggers reside within a presence context and associate a sequence of steps (or logic flows) based on an underlying presence state change detected based on information provided by the presence platform. Triggers are conceptually similar to database triggers. Triggers stand alone from rules and are a special form of Aspect trigger with an associated action. Therefore, a trigger sits on one or more rule(s) (e.g. to establish when a presentity Bob moves from unreachable to reachable), and has logic to determine when the trigger ‘fires’ (based on the detected change). As a result of a trigger firing, logic (i.e. in the form of one or more rules or predefined actions) executes. Examples of predefined actions that may occur based on a trigger firing include, for example, inviting a user to a communication session, terminating a given communication session or application, or simply sending a given user a notification (e.g. notify Alice that Bob is now reachable).

Triggers are formulated as part of an access layer, within a context. Therefore, like rules and policies, triggers are established in a similar manner. The basis for establishing may be identical to the others, and can include factors such as the service the client is using, optionally a client watcher ID, and optionally the user identifier(s) of the entities that watcher is observing or interacting with.

Table 4 lists a set of triggers relating to the computation of presence related aspects with pseudo-logic specific to the particular trigger. It should be noted that aspects may also be associated with a corresponding trigger definition.

TABLE 4
Triggers

| Trigger | Description | Pseudo-logic (action) | |
|---|---|---|---|
| onOptIn/Out | Application defined | ▪ | notification(default) |
| | trigger which is | | |
| | invoked when a | | |
| | presentity is | | |
| | determined to have | | |
| | opted-in/out for the | | |
| | given service or | | |
| | application | | |
| onUn/Available | Application defined | ▪ | notification (default) |
| | trigger which is | | |
| | invoked when a | | |
| | presentity is | | |
| | un/available for the | | |
| | given service or | | |
| | application. | | |
| onUn/Reachable | An application | ▪ | notification (default) |
| | defined trigger | | |
| | which is invoked | | |
| | when a presentity | | |
| | is un/reachable for | | |
| | the given service | | |
| | or application. | | |
| onNearby/onOutOfRange | Invoked when a | ▪ | notification (default) |
| | presentity is nearby | | |
| | or they have moved | | |
| | out of a specified | | |
| | range for the given | | |
| | service or | | |
| | application. | | |
| on-pending-subscription | Invoked when a | ▪ | notification w/list<AOR> |
| | presentity has one | | (default) |
| | or more | | |
| | subscriptions in a | | |
| | ‘pending’ state. | | |
| on-terminated-subscription | Invoked when a | ▪ | notification w/list<AOR> |
| | presentity has one | | (default) |
| | or more | | |
| | subscriptions in a | | |
| | ‘terminated’ state. | | |
| on-update-note | When a presentity | ▪ | notification w/note-text (default) |
| | adds or updates a | | |
| | personal note. | | |
| on-is-in/eligible-session- | When a presentity | ▪ | notification (default) |
| participant | is un/reachable and | | |
| | in/eligible for the | | |
| | given service or | | |
| | application. | | |
| on-activity-update | When a presentity | ▪ | OTA Notification w/activity-text |
| | adds or updates | | (default) |
| | an activity. | | |
| on-barred-active/on- | When a presentity | ▪ | OTA Notification (default) |
| barred-terminated | is barred | | |
| | (active)/un-barred | | |
| | (terminated) for the | | |
| | given comm. | | |
| | service. | | |
| on-registration-active/on- | When a presentity | ▪ | OTA Notification (default) |
| registration-terminated | is registerd | | |
| | (active)/un- | | |
| | registered | | |
| | (terminated) for the | | |
| | given comm. | | |
| | service. | | |
| on-location-change | When a presentity | ▪ | OTA Notification w/location |
| | is determined to | | information (default) |
| | have changed | | |
| | location (e.g. geo- | | |
| | coordinates, or | | |
| | location tag) for | | |
| | the associated | | |
| | comm. service. | | |
| on-icon-change | When a presentity | ▪ | OTA Notification w/icon URI |
| | is determined to | | (default) |
| | have changed their | | |
| | icon (e.g. their | | |
| | person or service | | |
| | related icon). | | |
| on-mood-change | When a presentity | ▪ | OTA Notification w/mood |
| | is determined to | | information (default). |
| | have changed their | | |
| | personal mood. | | |
| onNetworkAvailable/UnAvailable | When a presentity | ▪ | OTA Nofification w/network |
| | device is detected | | home/visited network indicator |
| | to be network | | (default). |
| | available/un- | | |
| | available | | |
| | (applicable to a | | |
| | home or visited | | |
| | network). | | |
| on-icon-metadata-change | When the | ▪ | OTA Notification w/tuple - icon |
| | associated icon | | URI, metadata change(s) |
| | metadata (e.g. | | (default) |
| | contenttype, etag) | | |
| | changes for a | | |
| | given presentity. | | |
| on-relative-service- | When a | ▪ | OTA Notification (default) |
| preference-change | presentity's | | |
| | relative service | | |
| | preference has | | |
| | changed. | | |
| on-session- | When a presentity | ▪ | OTA Notification w/service |
| involved/uninvoled | is currently | | identifier (default) |
| | involved | | |
| | (participating)/unin- | | |
| | volved (not | | |
| | participating) in an | | |
| | associated session | | |
| | of the given comm. | | |
| | service. | | |
| on-session-count-change | When total number | ▪ | OTA Notification w/total number |
| | of communications | | of sessions |
| | sessions presentity | | |
| | is involved in | | |
| | changes | | |
| on-timezone-change | When a presentity | ▪ | OTA Notification w/time-offset |
| | is determined to | | (default) |
| | have changed | | |
| | timezone (relative | | |
| | to UTC). | | |
| on-personal-interest- | When a presentity | ▪ | OTA Notification w/personal- |
| change | is determined to | | interest update (default) |
| | have changed their | | |
| | personal interests | | |
| | (e.g. hobbies). | | |

For example, the first trigger in Table 4 above indicates that the trigger will be invoked when a presentity is detected to have opted in or out of a given service or application. The trigger allows specific functionality (i.e. a predefined action) to be carried out when the associated state is detected relative to a given context. The pseudo-logic can be defined by the application client if the client wishes the P/CAM to do something on the occurrence of a given event which is when a trigger is invoked.

The other triggers defined by Table 4 have similar functionality and are invoked pursuant to a predefined condition being met.

Triggers are useful in a complex presence-aware system. Triggers provide a specific functionality to be defined and applied for a given scenario (e.g. perform operation x when Presentity ‘Bob’ has optedOut of service MyFriendlyChat). Triggers, in one embodiment, provide a simple notification to a client or service or may incorporate complex business logic that is executed by a context aware layer. This is helpful within a wireless domain where network bandwidth and processing resources are limited.

For example, a wireless content delivery service may have specific behavior based on the state of users and their associated device capabilities. That is, two users who have opted in for a sports ticker/alert service with different devices may receive content in different ways. For example, a first user who has a very simple text based wireless device and is only able to receive short message service (SMS) with baseball related content and/or a web-based URL pointing to additional information has different data than a second user who has a full featured personal digital assistant/smart phone with a built in media handling capability. The second user may receive multimedia alert messages containing short full-color video clips of a sports ‘play of the day’.

Each case above illustrates the underlying complexity of a content delivery service for delivering appropriate/timely content relevant to each user's device. That is, a content delivery service typically has some understanding of a given user's current state, along with their associated interests, and the relevant device capabilities for receiving content. A content delivery service working in combination with a contextually aware presence capability is such a platform. Further, a contextually aware platform that exposes relevant “aspect triggers” on behalf of a content delivery service provides useful means for notifying or pushing relevant information to an associated subscriber base.

An aspect with an associated trigger is a “monitored aspect” on a continuous or specified basis, as provided below. That is, when an entity, whether a person or a logical entity, reaches or qualifies for an associated aspect trigger, the associated trigger “fires,” and a set of logics or actions takes place. The logic is based on a rule as part of the context, and is therefore contextual in nature. Further logic allows services, user specific actions, or both, to be defined and executed. This logic may include sending or pushing relevant information to an appropriate client device. As with aspects, aspect triggers may be expanded to encapsulate a variety of non-presence indicators such as location.

The present systems and methods include a mechanism for an arbitrary number of aspects by the service/presence platform. This may include a set of common aspect triggers such as “availability”, “opt-in”, “reachable”, among others, as well as application specific triggers. A method exists in one embodiment within the presence platform or management interface for associating an appropriate set of aspect triggers with a given service. Association of aspect triggers is contextual in nature and may apply at different levels. For example, a given aspect trigger may apply to a service enabler such as OMA push-to-talk over cellular (PoC) compliant services. Further, the trigger may be applicable or scoped at a class of service level. For example, this may apply “availability” to all class of services. Further, a trigger may be applicable at a user or group level.

The determination of whether a client is “reachable” is simplified by abstracting the aspect to the context aware layer. Further, a trigger can invoke the aspect or the aspect can be invoked on behalf of the trigger. This could be done by the underlying service enabler without any involvement from any client device. Triggers may invoke defined aspects, may incorporate logic consisting of rules/procedures which include the invocation of other aspects, or both.

Aspect triggers by default will send an appropriate notification back to an associated client. However, it is possible for a service, class-of-service, enabler, user or group to modify/define a trigger which performs actions exclusively within the network without any client involvement.

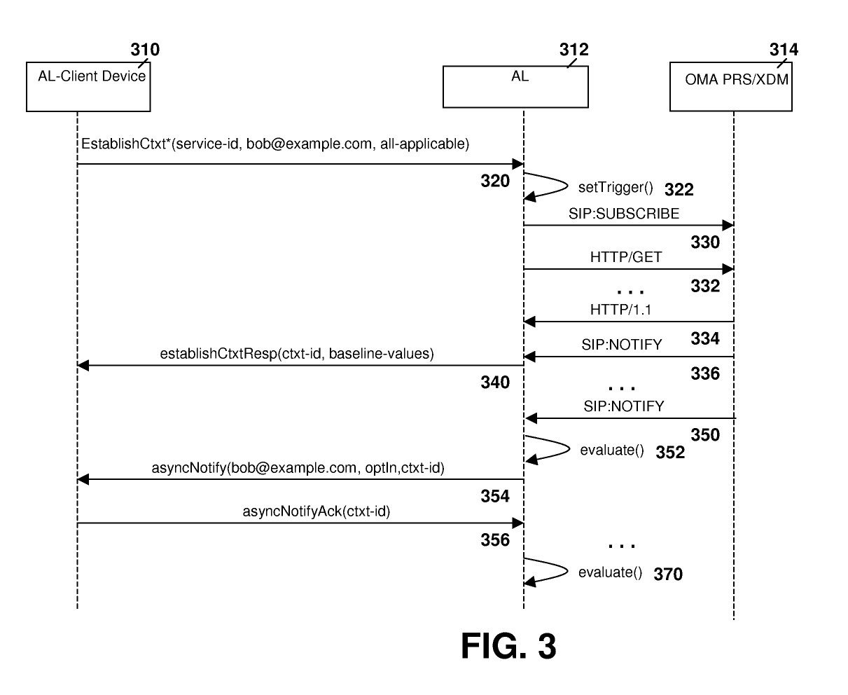

Referring to FIG. 3, a client device 310 communicates with an access layer (AL) 312. AL 312 further communicates with a presence service, a network database or document storage (e.g. an XDMS), or both, shown as OMA PRS/XDM 314 in FIG. 3.

A context is established with message 320 sent from client device 310 to AL 312. The context establishment message includes a service identifier to identify the service for which the context is requested, a target, which in this case is a single presentity “Bob”, and a list of aspects that the context is interested in. In the case of message 320 the list of aspects is “all-applicable” indicating that all aspects for the service identified by service-ID are relevant and should be evaluated/provided to client device 310 as part of the context establishment response.

In response to message 320, AL 312 checks whether there are any triggers associated with the context to be established, and if yes the trigger is set, as shown by arrow 322. As will be appreciated, arrow 322 would only occur if client device 310 has requested aspect values for aspects that overlap with defined triggers (i.e. a one to one correspondence between at least one aspect and a trigger). Such requested aspect values could, for example, be provided as part of establishment message 320 in one embodiment.

Setting the trigger indicates that the AL 312 will monitor aspects and changes to aspects for the context, as described in more detail below in the section entitled “Monitoring”.

AL 312 then sends a subscription message 330 to OMA PRS/XDM 314 to establish a subscription with the relevant presence service. Further, AL 312 sends an HTTP/GET message 332 to OMA PRS/XDM 314 to obtain aspect baseline values.

In response to the HTTP/GET message 332, OMA PRS/XDM 314 responds with an HTTP/1.1 response 334 providing aspect values. In addition, a SIP:NOTIFY response 336 is returned based on the subscription message 330.

AL 312 provides the establishCtxtResp(ctxt-id, baseline-values) message 340 in response. The message includes a context identifier as well as baseline values for the requested aspects. These aspects are now being monitored by AL 312 on behalf of client device 310, for the context.

At a subsequent point, a SIP:NOTIFY message 350 is provided from OMA PRS/XDM 314 to AL 312. Message 350 may include new values associated with various aspects being monitored by AL 312. An evaluation 352 is performed at AL 312. Evaluation 352 determines whether any triggers are interested in the change, as described in the “Monitoring” section below.

The results of the evaluation 352 are that the “optIn” aspect for Bob has changed for the context defined by ctxt-id. The trigger for the context has specific actions defined when an aspect value changes. Such actions can be defined individually for each context. In the example of FIG. 3 the action is to provide an asynchronous notification to client device 310. This asynchronous notification is shown as message 354 and includes the target (i.e. the observable), the updated aspect value and context identifier for device 310.

In response to receiving message 354 an acknowledgment may be provided from device 310 to AL 312, shown by message 356.

AL 312 then continues to evaluate subsequent notifications, as shown by arrow 370.

Triggers have actions associated with them. For example, given that triggers may be calculated or derived within a network, an interested observer, whether a client device or interworking service/enabler, may receive an unprompted or asynchronous notification as a result of an aspect trigger. Notifications may be handled using different communication means. For example, a client device may receive an SMS notification as a result of an aspect trigger firing. Additionally other services may receive an OMA SIP/PUSH 1.0 notification or notifications in response to an associated trigger.

The contents of a notification are specific to the trigger and could include items such as the address of record for one or more presentities, an aspect indicator or mask for one or more aspects of relevance (i.e. detected to have changed), a URL, a service or application routing mask for the receiving entity to ensure the aspect is directed or associated with the appropriate observer, among others.

Each client or service receiving a resulting notification may respond according to the associated transport protocol. Additionally, it is possible for aspect trigger indications to be durable. That is, if a trigger is calculated for a given “interested observer” but that observer is unreachable, the aspect indication may be held or queued until the given user is able to properly receive the associated trigger. This is useful for scenarios where a given notification may outlast a given client user session.

The above policies, aspects and rules/thresholds as well as trigger actions could utilize a web services business process execution language in the form of WSBPEL 2.0. In other embodiments, expressing rules could be performed utilizing a traditional programming language (e.g. Java, JavaScript, or Ruby) or diagraming tools (e.g. a Sequence, Flow-Chart, or Use-Case diagram in UML being translated to a rule(s) in a particular target programming language or expression).

As will be appreciated by those skilled in the art, the use of a context aware layer saves device and network resources by reducing the amount of information flowing between a mobile device and a network, and by removing processing from the mobile device.

### Monitoring

One part of a context aware layer is the ability for the context to refer to information triggers. Information triggers typically monitor changes to aspects of relevance for a given logical observer. If an aspect value is detected to have changed, then a predefined action can be invoked or fired in response to the detected change. For example, in the case of presence information, a context layer, such as a Presence Access Layer (PAL) server executes a predefined action for that specific presence trigger. The action could include various functionality, including, but not limited to, sending an asynchronous notification towards the logical observer such as a PAL client; or sending information to a logical observer which includes metadata describing how one or more affected entities may be invited to an associated communication session. Thus, the functionality/action could be to invite a sequence of “college buddies” to a group Instant Messaging (IM) chat when they are all detected to be “contactable” and have “OptedIn” for the IM chat service.

In some cases, location information and values could have associated triggers that are monitored by a context aware layer. The example provided above could be extended to include “college buddies” who are “contactable”, “opted in/willing”, and “in proximity” (i.e. less than 2 km) of one another.

One issue with the context aware layer mechanism monitoring underlying information is how the context aware layer mechanism performs the monitoring without an overt directive (e.g. a subscription) from an associated logical observer. For example, how does a PAL server monitor the presence triggers on behalf of a PAL client when a PAL server does not have any information regarding which presentities to monitor? Further, how does a PAL server perform presence or location trigger monitoring when a presence or location context contains no information about presentities or targets a given PAL or AL client may be interested in?

The above may be solved through a two-fold solution. As a first portion of the solution, during context establishment on behalf of a PAL client, the PAL client is permitted to specify one or more of a single presentity, a plurality of presentities or a sequence of presentities provided as part of a presence contained list (i.e. a list stored somewhere else—for example, it may be the network which refers to one or more presentities). Also, the type of information to monitor (i.e. in the form of aspects) may be specified. Such information may include presence, location or a combination of the two, among others. Other information specified may include a monitoring duration.

A second part of the solution is to provide an ongoing mechanism for a PAL client to specify one or more of a single presentity, a plurality of presentities or a sequence of presentities provided as part of a presence contained list, when requesting presence or location aspect values from a PAL server. The mechanism may form part of a normal way for a PAL Client to receive aspect values of interested parties. A duration can be utilized as a means to specify by the PAL client how long a particular presence aspect for a given presence context is to be monitored. Also, a local policy or configuration parameter may be utilized as a means to specify how long monitoring may continue and whether a subsequent request for a presence aspect are additive in terms of what is monitored versus new information. In other words, the policy/configuration may be specified to automatically eject or replace the last set of aspects to be monitored when a new set of aspect values are requested by a PAL client.

As part of the solution, the context aware layer may determine or infer that given the associated context requires monitoring of aspects, and that there are “entities” to monitor for a specified duration, then the x/CAM may attribute the applicable context for the logical observer “monitoring”. That is, the context has an associated list of “to be observed/monitored” entities which the context layer will begin monitoring for applicable changes (i.e. relevant to triggers established for any non-terminated contexts). The duration of monitoring, as previously indicated, may be indicated by a logical observer, could be a default value associated with the context or the service related to the context, or a combination of the two. The duration may also be specified using local configuration at the context aware layer itself.

In one embodiment, once a context is established as “monitoring capable”, as defined above, and it may be stored or held on behalf of a context aware layer in a tracking table or structure, which may be utilized by the x/CAM to determine which received notifications are to be associated with a particular context. In other words, the received notifications coming from underlying information owning services are tracked and are filtered based on whether they are associated with particular contexts. As will be appreciated, the tracking table may already exist for the purposes of tracking “outstanding” active presence contexts for one or more PAL clients.

In a further embodiment, baseline aspect values that are relevant for the calculation of a given information aspect associated with an applicable trigger, may be stored within a tracking table to establish the most up to date set of aspect values relevant to the context, and by extension to the Logical Observer.

The “monitoring” state may be established in two phases. In a first phase, the PAL client establishes a Presence Context and as a result the resulting context becomes “monitoring capable”. As a result of a change in status, the PAL server will identify and invoke “monitoring” when the first Presence Aspect request for which an applicable trigger is defined, is received by a PAL Client for the given Presence Context identifier. The condition for a Presence Context monitor to be considered “true” is that it has at least one Presence Trigger (for a corresponding Presence Aspect defined as part of the Presence Context), and that the context has monitoring “true” for at least one Presence Trigger associated with the context. Parameters such as “duration”, “priority”, level-interest along with quality of service indicators (QoS) may impact the actual monitoring process itself. For example, a change to “level-of-interest” may impact the resulting Presence Server subscription established by the PAL server and thus the monitoring status of the PAL Presence context may automatically become “false”.

In yet another embodiment, policy and or local configuration may be used by the x/CAM to determine the scope of “observed entities to monitor”. That is a decision is made on whether each successive aspect value request by a Logical Observer forces the x/CAM to eject or remove a Context from being monitored. Alternatively, a policy or local configuration may specify an x/CAM maintain a “cumulative monitoring” for the “union of non-overlapping observed entities/aspects” for triggers associated to a given context.

In a further embodiment, the duration or specified length of time for monitoring Information Triggers applicable to a context is provided or derived based on:
An overt indication by a Logical Observer;
Policy or local configuration associated with a “Context-aware” service;
The end of the service session (that is the context itself is terminated, meaning duration no longer applies for any trigger of the context); or
A combination of one or more of the above.

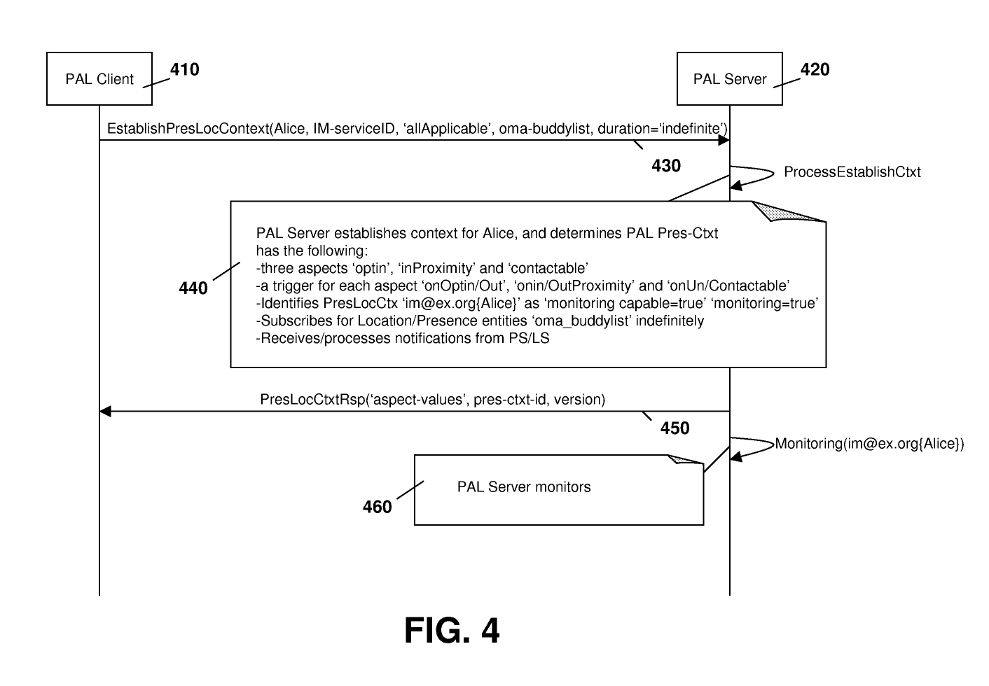

The above may be illustrated by way of example. Reference is now made to FIG. 4. FIG. 4 shows communication between a PAL Client 410 and a PAL Server 420. The PAL Server 420 is configured to monitor aspects based on applicable triggers for a given context, once a context is established between PAL Client 410 and PAL Server 420. In the example of FIG. 4, PAL Client 410 is on a device owned by a Logical Observer. For example, PAL Client 410 may belong to Logical Observer “Alice” who has an instant messaging application on her device called “MyFriendlyChat”. MyFriendlyChat provides Alice with the ability to communicate with her buddies if three Aspects have a specific state. In particular, the aspects that IM client “MyFriendlyChat” requires are “OptIn”, “Contactable”, and “In Proximity”. The “OptIn” aspect determines whether an Observer has opted in to the MyFriendlyChat communication.

The “Contactable” aspect determines whether a presentity is contactable by the Observer. The “InProximity” is a location-based aspect which determines whether the presentity is within a specified proximity (e.g. less than 2 km) to the Observer.

Referring to FIG. 4, in order to establish the monitoring of these aspects by PAL Server 420, PAL Client 410 sends a message 430 to PAL Server 420. Message 430 is a message “EstablishPresLocContext(Alice, IM ‘allApplicable’, oma-buddylist, duration=‘indefinite’), which in this case is a request by the Logical Observer to the Presence/Location context establishment of an x/CAM such as a PAL Server for Presence/Location aware service instant messaging application “MyFriendlyChat”.

In establishment message 430 the Observer is identified, the application is identified, the aspects that are to be requested and monitored are specified as “all-applicable”, the presentities are presented as the ‘oma-buddylist’ for Observer Alice, and the duration is specified as indefinite. In other embodiments, the duration may be determined or evaluated by PAL server 420 to be indefinite or some relevant value. As will be appreciated by those skilled in the art, the ‘oma-buddylist’ is a predefined list of presentities specified as part of OMA PRS SIMPLE, for the use of watchers (e.g. such as Alice).

As a result of message 430, PAL Server 420 authorizes the Presence/Location Context Establishment Request from Alice's PAL Client. It also determines the following, as shown by arrow 440:
Presence/Location Context identifier ‘im@ex.org{Alice}’
Presence/Location Context ‘foo{Alice}’ for user Alice, has three Aspects:
   optIn—Presentity ‘x’ has opted in for IM service;
   inProximity—Presentity ‘x’ is nearby to participate for a communication session;
   contactable—Presentity ‘x’ is contactable for an IM session.
Presence/Location Context ‘foo{Alice}’ for user Alice has a Trigger for each Presence/Location Aspects:
   onOptIn/onOptOut—detects when Presentity ‘x’ has opted in/out for IM;
   onInProximity/onOutProximity—detects when Presentity ‘x’ is in/out of proximity for a communication session.
   onContactable/onUncontactable—detects when Presentity ‘x’ is contactable/uncontactable for IM.
   Location-detects when Presentity ‘x’ has changed its location.
PAL Server establishes back-end requests (e.g. subscriptions) for a requested list of Location/Presence entities (e.g. the ‘oma_buddylist’ list for user Alice)
PAL Server receives underlying information (e.g. presence and location Information) from presence and location sources, and establishes baseline aspect values for the applicable Presence/Location Context
An appropriate response, including Presence/Location Context identifier, and presence/location Aspect (baseline) values for Alice's ‘oma_buddylist’ are provided as a result.

The triggers are established at arrow 440, which also establishes that a monitoring capable Context with one or more triggers exists and thus changes the state of the Context to “monitoring capable”. Further, since at least one target was specified and the monitoring duration is defined as indefinite, the aggregate state of the monitoring becomes true. Monitoring is also established for each trigger (in the case of Alice's context, this applies to each of the three aspects for context ‘im@ex.org{Alice}’).

As a result of the actions at arrow 440, PAL Server 420 returns message 450 to PAL Client 410. Message 450 is PresLocCtxtRsp (“baseline aspect values”, pres-ctxt-id, version). The message 450 is a result of the processing at arrow 440, which includes the establishment of backend requests such as subscriptions/processing for a requested list of Location/Presence Entities by a PAL Server 420 on behalf of PAL Client (Alice) 410.

Once the monitoring is established, monitoring continues, as shown by arrow 460, based on the PAL server:
1) Processing resulting notifications received from a PS based on established subscriptions, in accordance with the PAL Server:
   Establishing a subscription towards the PS for specified Presentities, including whether Presence Triggers are to be monitored for specified Presentities, in which case a PAL Server uses:
      ‘Duration’ to establish length of time a PAL Server should monitor Presence Triggers for specified Presentities, on behalf of a requesting PAL Client (i.e. a PAL Server determines an applicable subscription duration when establishing a subscription toward the PS);
      Request Parameter ‘Priority’ and the level of QoS, to determine the frequency at which a PAL Server should receive notifications from a PS (i.e. when a PAL Server subscribes to receive Presence Information of specified Presentities on behalf of a PAL Client,
      Request Parameter ‘InterestLevel’ and the level of QoS, to determine the granularity of information transmitted to a PAL Server associated with received notifications from a PS (i.e. when a PAL Server subscribes to receive Presence Information of specified Presentities on behalf of a PAL Client).
      Process resulting event notifications received from a PS as a result of the subscriptions established in the preceding step, including:
      Resolve applicable PAL Rules and Policy based on PAL Presence Parameters associated with the specified Presence Context, and local PAL Rules and Policy corresponding to the requesting PAL Client.
   Invoke PAL Rules utilizing PAL Policy based on the results of the preceding step, to evaluate and consolidate Presence Information in the form of Presence Aspect values;
2) Identifying, based on the results of the preceding step, a Presence Context for which we have received updated Presence Aspect values, and for each ‘monitoring’ Presence Context:
   a) Invoke PAL Rules corresponding to Presence Triggers of the Presence Context to determine whether Presence Aspect values of Presentities, received during processing (i.e. from step 1), have changed; and,
   b) If one or more Presence Aspect values have changed for the Presence Context, execute a predefined action applicable to Presence Trigger.
3) Re-evaluating each ‘monitoring’ Presence Context having ‘non-terminated’ state to establish whether monitoring should continue for a given Presence Context, based on specific factors (e.g. duration, ‘monitoring’ Presence Context is being terminated, etc.).
4) If the results of step 3 indicate one or more ‘monitoring’ Presence Contexts, then repeating this procedure beginning at step 1.

As will be appreciated, given the particular Presence/Location Context has Triggers defined for it, the PAL Server is able to determine that it should maintain this particular non-suspended Presence/Location Context as “monitoring capable” and if the requesting PAL Client has included a list of one or more Presentities and the duration for the aspect has not expired then the context is also ‘monitoring’. As a result, a PAL Server may establish Alice's im@ex.org{Alice}:/01 Presence/Location Context within its tracking table, including baseline values. Baseline values stored within the tracking table, may include both monitoring trigger aspect values, as well as established baseline values which are not deemed ‘monitoring’.

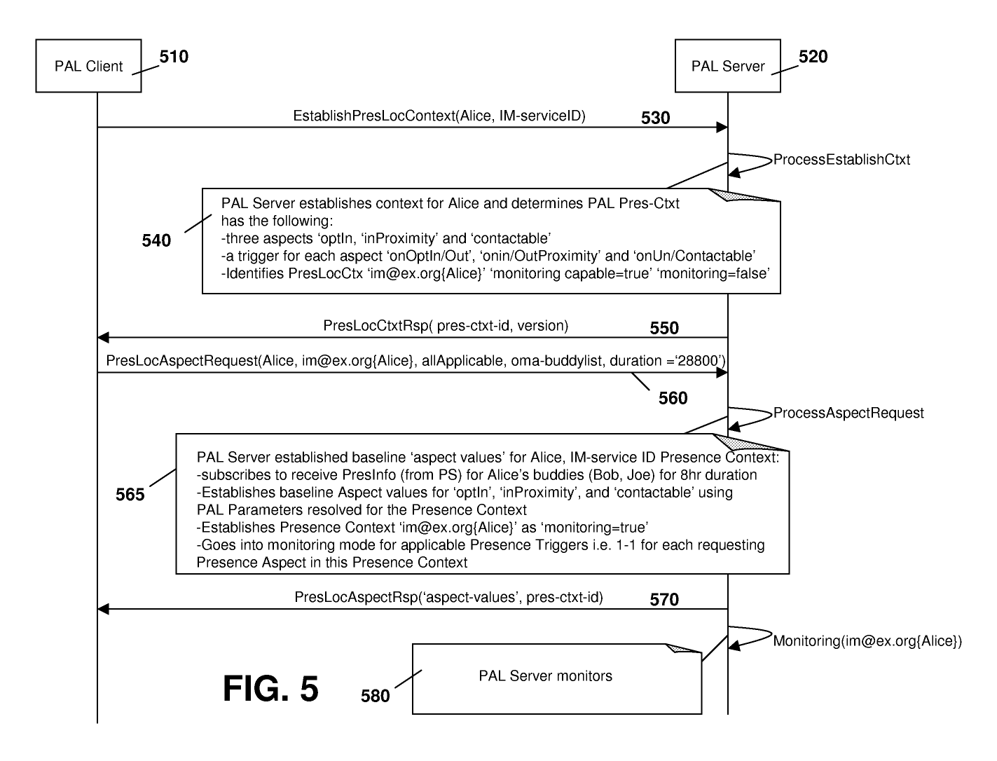

Reference is now made to FIG. 5. FIG. 5 provides an illustration of another use-case scenario for Alice. In this variation, Alice simply requests the establishment of her Presence Context, relative to the IM Presence aware service. Thus, referring to FIG. 5, Alice may cause message 530 to be sent from PAL Client 510 to PAL Server 520. Message 530 includes the “EstablishPresLocContext(Alice, IM-service ID).

As a result of the receipt of message 530 processing occurs at arrow 540 which shows that the PAL Server establishes a Context for Alice's IM service or application which may be partially executing on her device (and partially executing on an application server) and determines that the PAL Presence Context has three aspects, namely OptIn, inProximity, and contactable, as described above.

The Triggers for each aspect are identified and a Presence/Location Context “im@ex.org {Alice}” is established as ‘monitoring capable’ but monitoring is set to false since there are no aspects or Presentities provided within the establishment request.

The context is returned in message 550 as shown by PresLocCtxtRsp(Pres-Ctxt-ID, version).

The presence context in this case is “monitoring capable” since the context has triggers associated to aspects defined. However, the context will not be ‘monitoring’ since no Presentities were provided.

Subsequently, the PAL Client 510 sends a Presence/Location aspect request message 560 to PAL Server 520. The message 560 includes the context identifier, as well as an indication that all applicable aspects are to be monitored and that the presentities are the oma-buddylist and that the duration is a specified duration. Based on message 560, processing occurs as shown by arrow 565, which establishes baseline aspect values for Alice, subscribes to receive Presentity information from a Presentity server for Alice's buddies for the 8 hours duration specified. Further, baseline aspect values for optIn, inProximity and contactable aspects are set using PAL parameter resolved for the Presence Context.

Further, the processing at arrow 565 establishes the monitoring mode for applicable triggers to be true and begins monitoring the triggers associated with the context, for the various entities being monitored by Observer Alice. A message 570 is returned to PAL Client 510 providing the baseline aspect values as well as the presentity context identifier, the aspect values are associated with.

Subsequently, the PAL Server monitors the Triggers as outlined with relation to Table 4 above and as indicated with relation to arrow 460 from FIG. 4 above. This is shown by arrow 580 in FIG. 5.

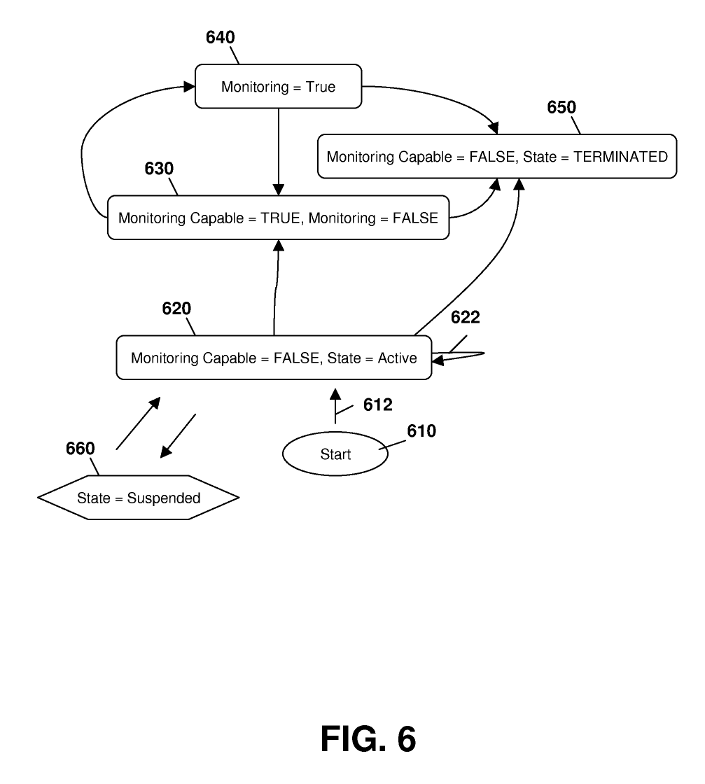

The overall state of the context is based on three sub-states. These are the status, whether the context is monitoring capable and whether the context is monitoring. The status can be in one of three states in the example of FIG. 6, namely “active”, “suspended” and “terminated”. The monitoring capable can be either true or false. Monitoring can also be true or false. FIG. 6 illustrates a state diagram showing transitions between the overall state for the context.

The state diagram of FIG. 6 starts at 610 and once a context establishment message is received proceeds to state 620. In state 620 the context has an active status and monitoring capable is “false”. The receipt of the context establishment message is shown by arrow 612.

From state 620, a check is made to determine whether or not triggers are associated with at least one aspect of the particular context. If yes, the state transitions to state 630 in which monitoring capable is true and monitoring is false. Conversely, if no triggers are associated with the context then the state remains in state 620 as shown by arrow 622. Thus, once a context establishment message is received, a check is made to determine whether triggers are associated with at least one aspect of the context, and if yes the state becomes state 630, and if no the state stays at state 620.

In state 630 a check is made to determine whether there are targets associated with the context. As will be appreciated by those in the art, without targets the monitoring stays false. However, if targets are specified then in one embodiment the state transitions to state 640 in which monitoring is true. As will be appreciated, the monitoring capable state is true as well.

Thus, to transition to a monitoring ‘true’ state, the monitoring capable must be true and at least one target must be identified. The target may be identified or specified in the context establishment request or subsequent to context establishment, for example in an aspect request. Also, to remain in the monitoring true state the duration of the monitoring must not have expired.

When a target is specified, often a duration for monitoring is also provided. This duration could include a fixed value or could be based on a rule or policy for the context. In one embodiment the lack of a particular duration within a context establishment or aspect request message could indicate an indefinite duration for monitoring. In other embodiments, the duration may be a derived value based on various factors that may be calculated or retrieved by an AL. For example, a duration may be specified or defined for a particular application or service, and by establishing the context the default or derived duration value is used when no duration is specified. In other embodiments, a combination of what is specified by a client may be combined with values known to the AL to derive or establish a duration.

Once a duration for monitoring expires, the state may transition from state 640 back to state 630, in which monitoring capable remains true and monitoring is false.

In states 620, 630 and 640 the status of the context could be “active’. However, this may change as shown by block 660 in which the status becomes “suspended”. The overall state can remain in state 620, 630 or 640 if the status of the context becomes suspended, and thus monitoring capable and monitoring will stay the same. For example, if a watcher turns off her device the state may remain in state 640 in which monitoring capable is true and monitoring is true. However, in this case the change in an aspect may not cause the action defined by the trigger to be performed. For example, if a presentity “Bob” decided to optIn to a service while the context for watcher Alice was in state 640, then the trigger might normally require an asynchronous notification to Alice. However, since the status of context Alice is suspended, the baseline value may be stored until the status for the context becomes active.

The status could also become “terminated”. In this case, the state will transition from any of states 620, 630 and 640 to state 650 in which monitoring capable becomes “false” and the status is terminated. Also, whenever monitoring capable becomes false, monitoring becomes undefined.

The status may become terminated for example if a watcher unsubscribes to a service. The status becoming “terminated” effectively ends the context and the monitoring for the context.

A PAL could implement the above in a presence system. In a generic system the above could be implement by an x/CAM. The PAL or x/CAM could for example be x/CAM 150, 155, 160 or 170 from FIG. 1. As would be appreciated, the x/CAM would utilize a processor, memory and a communications subsystem of a device or server to perform the above functionality.

Reference is now made to Table 5 below. Table 5 shows the various contexts that may be located on a PAL Server such as PAL Sever 420 or 520, their current state, the monitoring-capable status, monitoring status, and optionally baseline aspect values. As will be appreciated, the baseline aspect values may be located in a different location or different table.

TABLE 5
Context Monitoring

| | | Monitoring | | Baseline Aspect |
|---|---|---|---|---|
| Pres/LocCtxt-id | State | Capable | Monitoring | Values |
| im@ex.org{alice}:/01 | active | true | true[aggr] | Bob(optIn’F’, |
| | | | true[optIn/inProx/ | inProx’T’,contactable’T’) |
| | | | contactable] | Joe(optIn’T’, inProx’F’, |
| | | | | contactable’T’) |
| im@ex.org{bob}:/01 | active | false | undefined | <No Presence Triggers |
| | | | | defined> |
| im@ex.org{dave}:/01 | active | true | true[aggr] | Joe(optIn’T’, inProx’F’, |
| | | | true[optIn/inProx/ | contactable’T’) |
| | | | contactable] | |
| im@ex.org{joe}:/01 | terminated | false | undefined | Bob(optIn’F’, |
| | | | | inProx’T’, contactable’T’) |
| | | | | Dave(optIn’T’, inProx’F’, |
| | | | | contactable’T’) |
| im@ex.org{pete}:/01 | suspended | true | true[aggr] | Joe(optIn’T’, inProx’F’, |
| | | | true[optIn/inProx/ | contactable’T’) |
| | | | contactable] | |
| im@ex.org{mike}:/01 | active | true | false[aggr] | <no baseline values> |
| | | | false[empty-set] | |

In Table 5, the first row indicates that for the context for Alice for the IM service, the state is active, the context is capable of monitoring and the monitoring state is true. As indicated in the table, the monitoring=true may be specified for an aggregation of all the aspects or may be done on a per aspect or per group of aspects basis. Further, in one embodiment the aggregate monitoring state is never true unless there exists an individual trigger for the context which is currently monitoring (e.g. true[contactable] for Alice's context).

Alice is monitoring two Presentities, namely Bob and Joe. For Bob, OptIn is currently false, the inProximity aspect is true and contactable is true. Joe has a baseline value of OptIn as true, inProximity as false, and contactable is true.

Utilizing the methods of FIG. 4 or 5, if the aspect OptIn, inProximity, or contactable for either Bob or Joe changes, the trigger associated with the aspect will fire since the context state is active and the monitoring is true. The result may be that Alice will receive a notification of the aspect value change or some other action associated with the trigger.

Based on Table 5, during monitoring, a PAL Server will receive or retrieve information from the underlying information owning enabler. In this case, the PAL Server has established subscriptions toward a Presence Service and a Location Service on behalf of Alice and based on this when a Presentity from Alice's buddy list changes its Presence or Location information, the PAL Server may receive a notification from the Presence and/or Location service corresponding to a subscription on behalf of Alice. Given the PAL Server has established a context for Alice within its tracking table, including baseline values, the PAL Server would then proceed to:
Establish whether any received notifications apply to an active/monitoring context currently relevant for user Alice,
If yes, an evaluation is performed of the Presence information utilizing the x/CAM interoperable rules to establish updated aspect values for the “MyFriendlyChat”;
As a result, if a given Trigger fires a predefined action may result. Such predefined action may include, for example, an asynchronous notification, among other action; and
The rule corresponding to the notification fires, which causes the PAL Server to initiate a notification toward the PAL Client in the example of Table 5 and FIGS. 4 and 5.

Similarly, the second line of Table 5 includes the context for Bob for the IM service, which has a state of active, but is not monitoring capable. The monitoring is ‘undefined’ since the context is not monitoring capable. Further, no presence triggers are defined for Bob's context. As will be appreciated, monitoring capable is established once during the context establishment phase. As seen from FIG. 6, once a context is established and is “monitoring capable” or “monitoring incapable”, the only way to change this is to terminate and re-establish a context.

The third line includes a context for Dave for the IM service, and shows the state as active, monitoring capable and monitoring is true. In this case, the baseline values in Table 5 for the target ‘Joe’ are monitored.

The fourth line of Table 5 shows the context for Joe for the IM service, which has been terminated. Terminated in this case means that the context is no longer used and is removed from being monitored. For example, an application may un-subscribe to or drop a particular service, causing the context to be terminated.

Thus, the context may not be monitored if a request to terminate a context is received. If a request to terminate the context has been received or processed by a PAL Server, then a context is moving or has already moved from the active state to a terminating or terminated state. In this case monitoring is undefined. Therefore, in the case of a terminating context, an “already processed” information Trigger should be fired or executed and then the context terminated and/or removed from the tracking table. In other scenarios the context is simply removed immediately from the tracking table and further monitoring ceases.

The fifth line of Table 5 shows a context for Pete for the IM service, which is currently in a suspended state. The suspended state may, for example, be a state where the watcher has turned off his device but may resume the service when the device is reactivated.

The context for Pete is monitoring capable and monitoring, but no reporting will occur if baseline aspects change until the status for Pete's context changes from ‘suspended’ to ‘active’. At that point, an aggregation or breakdown of aspect value changes (while Pete's context was suspended) can be provided to Pete. Further, in cases where aspect values have been detected to change several times, the changes will only be reported if the state on activation differs from the baseline when the context was suspended.

The sixth line of Table 5 shows a context for Mike for the IM service, which is currently in a monitoring capable state, but has no targets, and thus monitoring is false.

The above table may be used by an x/CAM to quickly determine whether a reported change is relevant to any context and thus whether a trigger needs to be invoked. Specifically, if target “Joe” has opted in to the service, the underlying information will change and the x/CAM will receive a notification. The x/CAM can then quickly look through Table 5 to determine which contexts are watching target “Joe”. Further, once the contexts that are interested in this target are identified, a check can be made to determine whether the actual aspect value is relevant to that context. If yes, the trigger can be invoked and the action associated with the trigger for that particular context can be executed.

For target “Joe” having an aspect value “optIn” change, the first, third and fifth rows of Table 5 above are affected.

Further to the example above, the monitoring logical processes contained within the x/CAM needs to periodically revaluate whether one or more contacts should continue to be monitored. Factors which may influence whether they are monitoring or removed or excluded from the tracking table may include the duration which may expire if a finite duration is specified for a given context, if so, the resulting Presence Context may be removed from the tracking table or alternatively the monitoring may change to ‘false’ for the context.

The foregoing-described techniques may save the bandwidth and processing resources. If a PAL Server receives a notification from a Presence Service for an outside subscription, it may determine based on the active and monitoring states that the notification is not relevant and may be discarded. This has a net effect of ultimate bandwidth and processing overhead reduction, since the notification has no relevant information pertaining to any Presence Aware services or classes or services for that user's device.

Additional examples are provided below.

Instant Messaging Client

One exemplary client application for the use of a context aware layer is an instant messaging application. The instant messaging application is called “MyFriendlyChat” herein.

In a university setting, for example, several friends may have the “MyFriendlyChat” application loaded onto their mobile device. In this example, user Alice is a university student having finished a day of classes. She is heading towards the college restaurant and wonders whether any of her friends are nearby to join her for dinner.

Alice takes out her wireless device and starts the “MyFriendlyChat” application and invokes the “Invite-nearby-friends-to-chat” function. Initialization, registration, provisioning or use of the application may cause the establishment of a context 612/620, and since the service has aspects and aspect triggers associated with them, the context to be monitoring capable 630 from FIG. 6 above. Further, since targets were specified for example relative to an established buddy list, the state would transition to state 640 above where the monitoring is ‘true’ for aspects for the context of Alice for the MyFriendlyChat application.

The MyFriendlyChat utilizes both presence and location to return a list of friends that are within a predetermined distance and have a reachable status. The “MyFriendlyChat” application returns the active buddy list showing that Bob and Jane are nearby and reachable.

Alice enters a short message on her device letting her friends know that she is going to the college restaurant. Both Bob and Jane receive the message from Alice and reply that they will join her shortly.

The above shows a client application which utilizes both presence and location in order to make determinations and return relevant information to a user. In particular, the “invite-nearby-friends-to-chat” function may want knowledge of the location of nearby friends, as well as presence information to allow the instant messaging to occur.

Under a traditional model of instant messaging, a presence platform will be queried to obtain a list of raw data which must then be processed by the client application. Further, in this case a location platform could also be queried to find the location of individuals in a buddy list.

According to the present disclosure, the aspects can be abstracted to a context aware layer that is located within the network. The context aware layer can be part of a platform such as the location and presence platform, part of a dedicated server, part of a presence or location server, or could be distributed among these entities. In some cases an agent for the context aware layer could also exist on the wireless device or on another computer.

The functionality of the client application is placed within the context aware layer thus providing for consistent results between varied client applications and also reducing signaling between the mobile device and network.

For the above, the “MyFriendlyChat” client application functions as both a watcher and a presence source in an OMA/PRS realization and functions as a presence source in a context aware layer realization.

With regard to call flows, the client application must determine who is willing, reachable, and nearby to initiate a message datagram to invite these “buddies” to dinner. To fulfill this functionality, it is assumed that the “MyFriendlyChat” application subscribes to members of Alice's buddy list through OMA PRS/RLS components.

The client application thereafter may want to only to initiate communications towards eligible session participants based on the context aware layer result.

Various rules could be applied to the aspect to narrow it further. For example a limit could be placed on a subset of buddies when determining who is close by and reachable. Thus, the rule could be that only university buddies are returned when the request is made.

In a continuation of the above example, once Alice, Bob and Jane reach the restaurant, the monitoring may alert Alice if any of her friends come within a certain distance of the restaurant within a predetermined time period.

Mobile Advertising Scenario

In a further example of the above, car company XYZ Motor Cars wants an advertising campaign to coincide with the launch of a new sports-activity car model. XYZ Motor Cars hires Split-second Advertising Company to run the ad campaign and Split-second makes use of ABC Telecom as the wireless service/content delivery provider.

Split-second has established an advertising campaign for the new car model targeting individuals between 23 and 30 years of age with interests in biking, camping, kayaking. The ad contains various photos, video-clips or the like, of the new model being used with different sports activities.

Jack, Phyllis, Lynn and George have all agreed to receive advertising related content. Andrew is within the target market for XYZ Motors but has not opted to receive advertising content. Jack, Lynn and George are within the target market for XYZ Motors.

With the above scenario, ABC Advertising Company configures their wireless advertising platform for the advertising campaign. Monitoring is established for the various contexts, where aspects for the Split-second criteria are monitored for the given ad campaign, including whether a target has opted in to receive the advertising, is “reachable”, and has an appropriate device with capabilities of receiving an associated video clip.

ABC turns on the campaign to coincide with the launch date of the new model for XYZ, resulting in the context aware layer trigger, thus setting a ‘duration’ start time as a policy and causing the contexts to be ‘monitoring=true’ at the launch date.

A short time later, Jack, Lynn and George receive messages containing information related to the new vehicle being introduced by XYZ Motors. The ad content is adapted appropriately for each device. For example, Jack could receive a WAP-Push SMS with the WAP-URL to XYZ Motor's launch site while Lynn and George both receive multi-media messages (MMS) with a short video clip attached.

Since Phyllis and Andrew did not meet the criteria for the ad campaign, they are not contacted. However, if at a future time but still during the ad campaign, Andrew opts in to receive wireless advertising messages the XYZ Motor Company ad would be sent to Andrew.

The advertising example provides for a context aware layer utilizing two separate enablers working together. Specifically a mobile advertising and content delivery enabler are used to achieve a specific function point. Such interactions are not possible under present services.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method performed by a presence access layer (PAL) server, comprising:
receiving a message at the PAL server from a PAL client, the message requesting establishment of a presence context which is configured to provide abstracted presence information on behalf of the PAL client;
resolving an aspect based on the message to establish the presence context; and
configuring the presence context in a monitoring-capable state when a trigger is associated with the aspect.

2. The method of claim 1 further comprising:
monitoring the aspect for a change in a value of the aspect when the message specifies the aspect and a target.

3. The method of claim 2 further comprising:
receiving another message at the PAL server from the PAL client after the resolving, the another message requesting the value of the aspect,
wherein the another message causes the presence context to transition from the monitoring-capable state to a monitoring state.

4. The method of claim 3 wherein monitoring is performed for a specified duration.

5. The method of claim 4 further comprising:
transitioning the presence context from the monitoring state to the monitoring-capable state upon expiration of the specified duration.

6. The method of claim 2 wherein the target is a presentity or a buddy list.

7. The method of claim 3 further comprising:
performing a predefined action after the configuring relative to at least one of the aspect and the trigger when the presence context is in the monitoring state.

8. The method of claim 7 wherein the predefined action comprises sending an asynchronous notification to the PAL client relative to the aspect having a changed value.

9. A computing device comprising:
a transceiver configured to receive a message from a presence access layer (PAL) client, the message requesting establishment of a presence context which is configured to provide abstracted presence information on behalf of the PAL client; and
a processor configured to execute a PAL server agent for resolving an aspect based on the message to establish the presence context, and for configuring the presence context in a monitoring-capable state when a trigger is associated with the aspect.

10. The computing device of claim 9 wherein the processor is further configured to execute the PAL server agent for monitoring the aspect for a change in a value of the aspect when the message specifies the aspect and a target.

11. The computing device of claim 10 wherein the processor is further configured to execute the PAL server agent for:
receiving another message at the PAL server from the PAL client after resolving the aspect, the another message requesting the value of the aspect,
wherein the another message causes the presence context to transition from the monitoring-capable state to a monitoring state.

12. The computing device of claim 11 wherein the PAL server is configured to perform monitoring of the aspect for a specified duration.

13. The computing device of claim 12 wherein the processor is further configured to execute the PAL server agent for transitioning the presence context from the monitoring state to the monitoring-capable state upon expiration of the specified duration.

14. The computing device of claim 10 wherein the target is a presentity or a buddy list.

15. The computing device of claim 11 wherein the processor is further configured to execute the PAL server agent for performing a predefined action after the configuring relative to at least one of the aspect and the trigger when the presence context is in the monitoring state.

16. The computing device of claim 15 wherein the predefined action comprises sending an asynchronous notification to the PAL client relative to the aspect having a changed value.

17. A non-transitory computer-readable medium storing instructions thereon which, when executed, cause a computing device to execute a presence access layer (PAL) server configured to perform a method of:
receiving a message at the PAL server from a PAL client, the message requesting establishment of a presence context which is configured to provide abstracted presence information on behalf of the PAL client;
resolving an aspect based on the message to establish the presence context; and
configuring the presence context in a monitoring-capable state when a trigger is associated with the aspect.
